(19) United States
(12) Patent Application Publication
(10) Pub. No.: US 2017/0059390 A1
(43) Pub. Date: Mar. 2, 2017

(54) Method for Testing a Measuring Device

(71) Applicant: Endress + Hauser Process Solutions AG, Reinach (CH)

(72) Inventors: Matthias Brenzinger, Staufen (DE); Dominik Brand, Lorrach (DE); Toni Jehle, Hausen (DE); Emilio Schiavi, Oberwil (CH); Michael Moellgaard, Liestal (CH)

(73) Assignee: Endress+Hauser Process Solutions AG, Reinach (CH)

(21) Appl. No.: 15/119,417

(22) PCT Filed: Feb. 23, 2015
(86) PCT No.: PCT/EP2015/053674

§ 371 Date: Aug. 17, 2016

(30) Foreign Application Priority Data
Mar. 3, 2014 (DE) 10 2014 102 797.3

(51) Int. Cl. G01F 25/00; G01F 1/00

(52) U.S. Cl. CPC G01F 25/003; G01F 1/00

(57) ABSTRACT

A method for testing a measuring device using a reference measuring device, which is connected to a fieldbus system in a plant, to which fieldbus system, and a fieldbus access unit is connected. While testing the measuring device the measuring device remains connected to the fieldbus system and the measured values transmitted from the measuring device via the fieldbus system during the testing are transmitted by means of the fieldbus access unit to an evaluation unit, which evaluation unit is connected with the reference device, in order to compare the measured values of the measuring device with reference measured values of the reference measuring device.

The invention relates to a method for testing a measuring device, the use of the method, a fieldbus access unit and an arrangement comprising a measuring device, a reference measuring device, an evaluation unit and a fieldbus access unit.

For orderly operation and correct and exact conversion of the signal, measuring devices must usually be calibrated or regularly tested.

U.S. Pat. No. 7,117,122 discloses for this purpose an apparatus for diagnosis of a fieldbus by means of a fieldbus communicator. The fieldbus communicator can be operated with two different fieldbus protocols. In this way, a signal with known measured value is supplied to the input of a measuring device, and the supplied signal read back at the output of the apparatus. By comparing these two signals, it can be determined whether the transmitter is working correctly, i.e. whether the measuring device correctly converts the supplied signal. In such case, however, a calibration is only done in software, so that an actual testing of the functioning of a measuring transducer of the measuring device is not performed.

Known from the state of the art in the form of WO 2013117818 A1 is a calibrator functioning similarly to U.S. Pat. No. 7,117,122.

Known from patent application DE 102013105412 additionally is a calibration plant comprising an open fluid circuit and a closed fluid circuit. To this end, a measuring device to be tested is installed in the calibration plant.

Located in the calibration plant is at least one reference measuring device, which is exposed to the same process medium, preferably also to the same process conditions. In the case of a flow measuring device, thus, both the measuring device to be tested as well as also the reference measuring device are flowed through by the same amount of flow. The measured values output by the measuring devices can be compared and, thus, a statement can be made concerning the functioning of the measuring device. For such purpose, an evaluation unit is provided, which, for example, sets the flow amount, for example, by controlling pumps, and/or compares the measured values output by the measuring device and the reference measuring device with one another.

Such calibration facilities have, however, the disadvantage that the measuring device, which is to be tested, must be deinstalled from the plant, in which the field device is serving, and/or that the measuring device, which is to be tested, must be separated from the fieldbus system for control of the plant and connected with the evaluation unit. In such case, it is necessary to change the settings of the measuring device relevant for communication from those for control of the plant to those, which are used by the evaluation unit for control of the calibration plant. In this way, however, not only is the effort required for calibrating increased, but also additional sources of error are present in the changing of the settings of the measuring device.

An object of the invention is to provide a simpler and safer opportunity for testing a measuring device.

The object is achieved according to the invention by a method for testing a measuring device, the use of the method, a fieldbus access unit and an arrangement comprising a measuring device, a reference measuring device, an evaluation unit and a fieldbus access unit.

As regards the method, the object is achieved by a method for testing a measuring device using a reference measuring device, wherein the measuring device is connected to a fieldbus system in a plant, to which fieldbus system a fieldbus access unit is connected, wherein while testing the field device the field device remains connected to the fieldbus system and the measured values transmitted from the field device via the fieldbus system during the testing are transmitted by means of the fieldbus access unit to an evaluation unit, which evaluation unit is connected with the reference measuring device, in order to compare the measured values of the measuring device with reference measured values of the reference measuring device.

A fieldbus access unit, which is known, for example, from DE 102009045055 A1 and referred to there as a fieldbus interface, and serves there for retrieving diagnostic data of a field device from the superordinated bus system, is arranged in the communication architecture of a processing plant hierarchically most often parallel to a control system. The control system serves, in such case, for control of the processes running in a plant.

As a rule, measuring devices in modern plants of process automation technology are connected with one another via a fieldbus (such as, for example, Profibus, Foundation Fieldbus, etc.). The measuring devices are, in such case, also connected with superordinated units (for example a control system or a control unit), which superordinated units are likewise often connected with one another by a bus system superordinated to the fieldbus. These superordinated units serve, among other things, for process control, process visualizing, process monitoring as well as for start-up of the field devices.

Especially, the data exchange of the measuring device via the fieldbus occurs, in such case, according to a protocol (Profibus DP, Profibus PA, Foundation Fieldbus, etc.), which uses a plurality of individual parameter settings, for example, concerning the addressing of the individual stations on the fieldbus, the control of access to the measuring device, etc. Data, which include measured values and parameter settings, are, in such case, transmitted via the fieldbus in the form of telegrams according to the selected protocol.

The fieldbus access unit can be connected, for example, physically with the fieldbus. Via the connection, then a data exchange on the fieldbus can be tapped by the fieldbus access unit. The data, which are exchanged in the case of the established protocols in the form of telegrams, can be measured values as well as also the most varied of parameters and/or parameter values, which serve for control and/or observation of the process running in the plant.

The measured values produced by the measuring device during the testing are also transmitted during the testing via the fieldbus to the control unit for control of the process running in the plant. The measuring device transmits, at this point in time, the measured values, which are produced from a measured material used for the testing. The control unit queries these measured values via the fieldbus in accordance with a predetermined schedule. An evaluation unit is provided, in order to compare the measured values with those of the reference device, which reference measuring device serves for registering the same process variable of the measured material as the measuring device that is being tested. The measuring device is connected with the evaluation unit via the fieldbus and the fieldbus access unit, which on its part is connected with the fieldbus and the evaluation unit. The fieldbus access unit is, in such case, so configured, that it forwards to the evaluation unit the measured values registered by the measuring device to be tested.

In a form of embodiment of the method, the measured values are transmitted during the testing of the measuring device in cyclic data traffic via the fieldbus system. This means that at least two participants of the fieldbus exchange process data, such as, for example, measured values, in accordance with a fixed reporting cycle. This has especially compared with an acyclic data exchange the advantage that measured values can be downloaded from the measuring device faster and more reliably.

In an additional form of embodiment of the method, the measured values transmitted via the fieldbus system are registered by means of the fieldbus access unit during the testing of the measuring device. The fieldbus access unit is, for example, configured in such a manner that only those measured values of the measuring device, respectively of the fieldbus participant, are registered and/or forwarded, which should be tested, while the residual data transmitted via the fieldbus are rejected.

In another form of embodiment of the method, a measurement signal recorded by the measuring device is converted into a measured value, and such measured value is transmitted via the fieldbus system. The measurement signal, in such case, corresponds to the measured variable, respectively process variable, of the measured material used for the calibrating. In the case of a flow measuring device, this is, for example, the amount of flow of the measured material. The reference measuring device measures the amount of flow, respectively, likewise serves for determining the amount of flow. In the case of the reference measuring device, it can, in such case, likewise be, for example, a flow measuring device or, however, also a weighing scale, by means of which weighing scale the amount of flow is determined.

In an additional form of embodiment of the method, the measured value of the measuring device transferred via the fieldbus system is produced by means a first function block (TB), which serves for processing the measurement signal, and a second function block (AI), which serves to process the measurement signal processed by the first function block further. In this way, it can be assured that the measuring device outputs a correct measured value during use in the plant. Thus, in current usage, the Foundation Fieldbus protocol, for example, uses a number of function blocks, in order to process a measurement signal into a measured value. During a conventional calibrating, however, in given cases, only a first function block is used, in order to transmit to an evaluation unit a measurement signal, which was registered by means of a measuring transducer of the measuring device, while in measurement operation for monitoring and/or controlling a plant another function block enters in, which likewise serves for producing the measured value. This second function block contains, for example, a linearizing curve or the like

In an additional form of embodiment of the method, the measuring device remains during the testing in communication connection via the fieldbus system with a control unit of the plant, in which the measuring device is installed. For example, a pipeline system before and behind the measuring device can be opened, so that the measured material, which is used for the testing, is charged in front of the measuring device into the pipeline, passes through the measuring device and then drains behind the measuring device, or is fed to the reference measuring device.

In an additional form of embodiment of the method, the measuring device is for testing deinstalled from the plant, remains, however, in communication connection with the control unit, especially without the communication connection via the fieldbus system being interrupted. For example, the present wiring on the field device can thus remain, while it is deinstalled and installed in a calibration plant, such as, for example, a measured substance circuit.

In an additional form of embodiment of the method, the measuring device is operated with the same communication flow plan (link schedule) during the testing as during a preceding and/or following use in a plant. The communication flow plan determines the communication behavior of the measuring device. The measuring device is thus operated with the same communication flow plan as during measurement operation in the plant.

In an additional form of embodiment of the method, a measured value produced by the measuring device is provided during the testing according to the communication flow plan (deterministically), especially it is transmitted via the fieldbus system, and such measured value is taken into consideration in the evaluation unit for comparison with the reference device.

In an additional form of embodiment of the method, at least one identification datum of the measuring device is compared during the testing, preferably automatically, with reference data of the calibration- and evaluation unit, for example, in order to prevent error.

In an additional form of embodiment of the method, the fieldbus access unit is, on the one hand, connected with the fieldbus system, and, on the other hand, with the evaluation unit, for example, via an Ethernet connection. The connection between fieldbus access unit and the evaluation unit can thus be an Ethernet connection.

In an additional form of embodiment of the method, the reference device and/or the evaluation unit are/is part of a calibration system. The reference device can be part of a mobile calibration plant, which can be brought into the vicinity of the measuring device to be calibrated. The calibration plant can additionally comprise, for example, a fluid circuit, a fluid reservoir and/or the evaluation unit.

In an additional form of embodiment of the method, the reference device is not connected with the fieldbus system, with which the measuring device is connected. I.e., the reference measuring device is not a participant on the fieldbus, to which the measuring device is connected. Rather, the fieldbus access unit is connected with the fieldbus and also a participant on the fieldbus.

In an additional form of embodiment of the method, the measuring device is a flow measuring device.

In an additional form of embodiment of the method, the evaluation unit creates a protocol of the testing of the measuring device.

In an additional form of embodiment of the method, both the measuring device as well as also the reference measuring device serve for registering a process variable of a measured material. The measured material is, for example, a measured material (for example, a certain amount of water) used for calibrating.

As regards the use, the object is achieved by the use of the method as claimed in one of the preceding claims for calibrating, adjusting, validation or certification of the measuring device.

As regards the fieldbus access unit, the object is achieved by a fieldbus access unit for use in the method according to one of the preceding forms of embodiment. The fieldbus access unit includes for this purpose a corresponding configuration, in which data of a fieldbus participant are forwarded to an evaluation unit for the comparison of measured values with those of a reference measuring device.

As regards the arrangement, the object is achieved by an arrangement comprising a measuring device, a reference measuring device, an evaluation unit and a fieldbus access unit for performing the method according to one of the preceding forms of embodiment.

The invention will now be explained in greater detail based on the appended drawing, the sole FIGURE of which shows as follows:

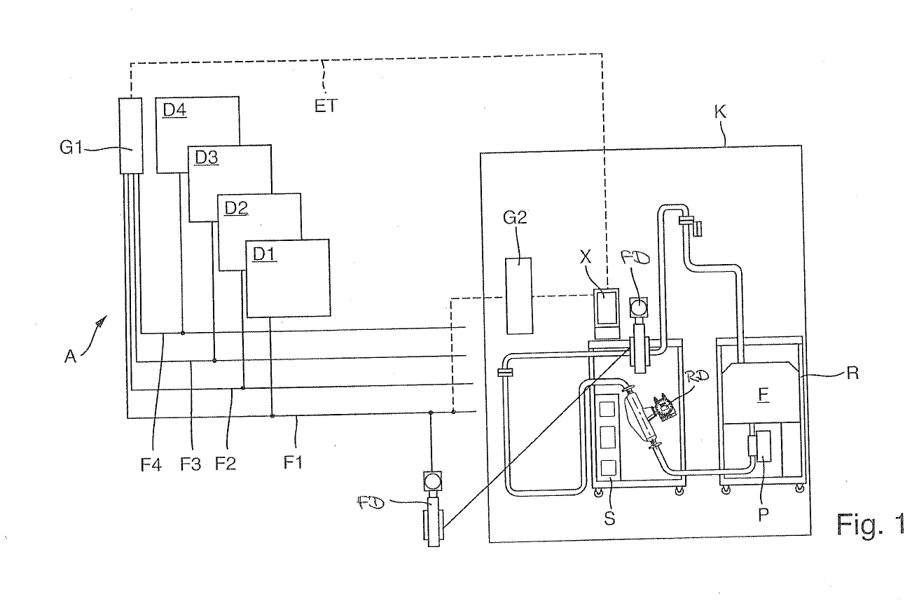

FIG. 1 a schematic representation of a form of embodiment of the proposed invention, including a measuring device to be tested, a first and a second fieldbus access unit, as well as a calibration plant.

FIG. 1 shows a schematic representation of a fieldbus F1, to which a measuring device FD (field device) is connected. Measuring device FD is, in such case, for example, part of a distributed control system DCS. Also provided is a central control unit D1, which has, for example, visualizing- and/or servicing means.

In order to calibrate or otherwise test the measuring device FD, it has so far been necessary to deinstall the measuring device FD from the plant A and to install it in a calibration plant K. Alternatively, it is also known to provide an inflow and an outflow in front of, respectively behind, the measuring device FD, so that it can remain at its installed location in the plant A.

Then, a measured material F is used, in order to ascertain a process variable of the measured material F by means of the measuring device FD and a reference measuring device RD.

According to one form of embodiment of the invention, the measuring device FD is no longer removed from the fieldbus F1, in order to connect it with the evaluation unit X, which serves for comparing the measured values ascertained by means of the measuring device FD and the reference measuring device RD. Rather, a fieldbus access unit G1, respectively G2, also referred to as a gateway, is used, which is connected to the fieldbus F1, to which the measuring device FD is connected, and which is also connected with the evaluation unit X.

The measured values ascertained by the measuring device FD during the calibrating and transmitted via the fieldbus F1 are then registered by means of the fieldbus access unit G1, respectively G2, and forwarded to the evaluation unit X.

For calibrating, the measuring device FD in the plant A can remain installed or be installed in a calibration plant, wherein the fieldbus connection of the measuring device FD is, however, not interrupted.

The fieldbus access unit G1, respectively G2, can according to a first form of embodiment be already installed in the plant A and for purposes of testing be connected with the evaluation unit X. On the other hand, the evaluation unit X can also be part of the calibration plant K and for purposes of testing be connected with the fieldbus F1.

If the fieldbus access unit G1 is continually connected with the fieldbus F1 of the plant, the fieldbus access unit G1 cannot only be connected with a first fieldbus F1, but, instead, also with at least one additional fieldbus F2, F3, F4. Thus, in simple manner, also measuring devices connected to these additional fieldbusses F2-F4 can be calibrated as proposed. Each of the fieldbusses F2, F3, F4 can, for example have its own control unit D2-D4, so that the fieldbusses F2, F3, F4 are both physically as well as also logically independent of one another.

Evaluation unit X can, in such case, be part of the calibration plant, such as shown in FIG. 1, and need only be connected with the one fieldbus access unit G1 connected to the fieldbus F1, respectively the fieldbusses F1-F4, for example, via an Ethernet connection ET.

Alternatively, the fieldbus access unit G2 can also be arranged in the calibration plant K and then be connected with the fieldbus F1, to which the measuring device FD to be tested is connected. Fieldbus access unit G2 can then alternatively also be connected to at least one other of the additional fieldbusses F2-F4.

Fieldbus access unit G2 thus provides a connection between the evaluation unit X and the measuring device FD to be tested. In such case, the measuring device FD does not, however, communicate directly with the fieldbus access unit G1, respectively G2, but, instead, with the control unit D1 and/or other measuring devices (not shown) connected to the fieldbus F1 in accordance with a communication flow plan also otherwise used in the plant A. The fieldbus access unit G1, respectively G2, serves, for example, at least during the calibrating for tapping the measured values transmitted by the measuring device FD via the fieldbus F1.

These measured values can then be used for comparison with the measured values produced by the reference measuring device RD. The comparison can then be used for calibrating, validating, adjusting the measuring device.

The calibration plant K can include one or also a number of reference measuring device(s), which are installed in a calibration circuit, through which a measured material F moves. The measured material F can be supplied, for example, by means of a pump P from a reservoir R, in which the measured material F is located. For control of the calibration plant K, likewise a control unit S can be used, which is installed in the calibration plant K and which is connected, for example, with the pump P. Additionally, the calibration plant K can include the evaluation unit X, which is connected with the reference measuring device RD.

1-16. (canceled)

17. A method for testing a measuring device using a reference measuring device, comprising the steps of:
connecting the measuring device to a fieldbus system in a plant, to which the fieldbus system and a fieldbus access unit are connected;
testing the measuring device while the measuring device remains connected to the fieldbus system;
transmitting the measured values transmitted from the measuring device via the fieldbus system during said testing by means of the fieldbus access unit to an evaluation unit; and
comparing the measured values of the measuring device with reference measured values of the reference measuring device by the evaluation unit which is connected with the reference device.

18. The method as claimed in claim 17, wherein:
the measured values are transmitted during the testing of the measuring device in cyclic data traffic via the fieldbus system.

19. The method as claimed in claim 17, wherein:
the measured values transmitted via the fieldbus system are registered by means of the fieldbus access unit during said testing of the measuring device.

20. The method as claimed in claim 17, wherein:
a measurement signal recorded by the measuring device is converted into a measured value, and such measured value is transmitted via the fieldbus system.

21. The method as claimed in claim 17, wherein:
the measured value of the measuring device transferred via the fieldbus system is produced by means of a first function block, which serves for processing the measurement signal, and a second function block, which serves to process the measurement signal processed by the first function block further.

22. The method as claimed in claim 17, wherein:
the measuring device remains during said testing in communication connection via the fieldbus system with a control unit of the plant, in which the measuring device is installed.

23. The method as claimed in claim 17, wherein:
the measuring device is, for testing, deinstalled from the plant, remains, however, further in communication connection with the control unit, especially without the communication connection via the fieldbus system being interrupted.

24. The method as claimed in claim 17, wherein:
the measuring device is operated with the same communication flow plan, for example, a so-called Macro Cycle Schedule, during said testing as during a preceding and/or following use in a plant; and
the communication flow plan determines the communication behavior of the measuring device.

25. The method as claimed in claim 17, wherein:
the fieldbus access unit is connected, on the one hand, with the fieldbus system, and, on the other hand, with the evaluation unit, for example, via an Ethernet connection.

26. The method as claimed in claim 25, wherein:
the reference device and/or the evaluation unit are/is part of a calibration system.

27. The method as claimed in claim 26, wherein:
the reference device is not connected with the fieldbus system, with which the measuring device is connected.

28. The method as claimed in claim 17, wherein:
the measuring device is a flow measuring device.

29. The method as claimed in claim 17, wherein:
a protocol of the testing of the measuring device is created by means of the evaluation unit.

30. The use of a method as claimed in claim 17, for calibrating, adjusting, validation or certification of a measuring device.

31. A fieldbus access unit for use in a method as claimed in claim 17.

32. An arrangement, comprising:
a measuring device;
a reference measuring device;
an evaluation unit; and
a fieldbus access unit for performing the method as claimed in claim 17.
